(19) United States
(12) Patent Application Publication
(10) Pub. No.: US 2026/0368306 A1
(43) Pub. Date: Nov. 19, 2026

(54) SYSTEM AND APPARATUS FOR SECURE COMPUTER SESSIONS

(71) Applicant: Jean-François Legault

(72) Inventor: Jean-François Legault

(21) Appl. No.: 19/207,687

(22) Filed: May 14, 2025

(51) Int. Cl. G06F 21/53; G09B 7/00

(52) U.S. Cl. CPC G06F 21/53; G09B 7/00; G06F 2221/033

(57) ABSTRACT

A system and apparatus for secure testing including an external device in the form of a USB flash drive to run an operating system on a student-owned machine providing a sealed environment for summative assessments. The system and apparatus provide a virtual classroom that precludes a student during the undertaking of a computerized testing session from using any software previously resident on their computer during the testing session. The system and apparatus establishes a testing session on the individual's computer that bypasses any software existing on the individual's computer including the computer's existing operating system. This provides a highly controlled environment during which the testing session may occur.

### TECHNICAL FIELD

The invention relates to testing administration in a secure environment. Moreover, the invention relates to a system and apparatus providing a secure environment on any computer used in the context of administering educational tests or assessments.

### BACKGROUND OF THE ART

There is currently a crisis in higher education. At a time when computers and digital skills are essential for almost every job, schools lack the funding to provide enough computers for every student to complete their written examinations and assessments within a controlled digital environment. Because it is not feasible for most educational settings to provide a computer to every student during peak assessment periods, teachers have no real choice in order to avoid discrimination due to budget constraints, but to eschew the use of computers for summative assessments. After COVID-19, the ‘Bring-Your-Own-Device’ (BYOD) approach may work in professional settings, but it is unsuitable for schools, particularly now that AI and conversational bots can easily perform many tasks meant to be assessed in exams. Because schools cannot provide enough computers, and allowing students to use their own devices would eliminate most safeguards against plagiarism and cheating, many teachers have reverted to administering exams using pen and paper thereby losing the efficiencies afforded by computerized advancements.

Known monitoring software solutions exist, and which are typically installed on a student's computer. However, such solutions often suffer from several problematic issues including installation consent requirements, security vulnerabilities, and imperfect integration with existing computer operating systems and resident software applications. In terms of consent for installation, the computer owner must consent to have the application installed on their device. This consent is often difficult to obtain as students are understandably wary of applications that give institutions significant control over their personal property. In terms of security vulnerabilities, these types of monitoring programs are not highly secure, and there are numerous ways to bypass the protections they offer. In other words, the environment they create for summative assessments cannot be guaranteed to be sealed and tamper-proof.

In terms of operating system integration, most computers on which these types of monitoring programs are installed run either Microsoft's “Windows” or Apple's “macOS”. To effectively block or access local or online storage, the software often must also restrict applications like Microsoft's “Office”. However, many of these programs are now so deeply integrated into operating systems whereby blocking access, such as to Microsoft's “OneDrive” within the Windows operating system, impairs the overall functionality of the computer. Due to these problematic issues, known monitoring software solutions which may be useful for a pool of school computers strictly managed and administered by an IT department have little to no practical efficacy for the BYOD model.

Overall, existing testing and assessment software is implemented as software embedded or otherwise installed within the computer used by the individual being assessed. Such known prior art software may serve to censure Internet access and lock down the computer used while being a browser-based interface. Thus, the locked-down browser needs to be downloaded to a computer thereby running as an overlay to applications pre-existing on the computer. The known software is often a large application, e.g., in the range of 50 MB, which may be too large and consume too much space for the given computer. Likewise, applications pre-existing on the computer may need to be shut down or otherwise deactivated in order for the prior art software to function.

Accordingly, what is needed is a solution providing a secure environment on any computer, including under the BYOD model, used in the context of administering educational tests or assessments which avoids the weaknesses of prior known implementations of testing and assessment solutions.

### SUMMARY

The present disclosure provides a system for securely administering assessments, the system comprising: an external device providing an operating system on a student-owned machine to create a sealed environment for summative assessments; one or more websites enabled by the operating system to be accessible by the student-owned machine; and a management component for enabling administration of the external device and the one or more websites.

During an assessment session, the student-owned machine may be precluded from using any preexisting software resident therein. The management component may include a web-based management platform. The external device may include a plurality of universal serial bus (USB) flash drives. The management component may further include a portable deployment case in communication with the web-based management platform, the portable deployment case being for containment of the plurality of USB flash drives.

The present disclosure also provides a system for securely administering assessments, the system comprising: a website accessible by at least two individuals including a test-taker and a test-provider; a plurality of universal serial bus (USB) drives, at least one of the USB drives configurable by the test-provider via the website, the USB drive enabling a secure session by the test-taker during an assessment; and a portable case configured to provide secure communications between the website and the USB drive.

The website may include a first administrative webpage for use by the test-provider and which enables the test-provider to configure the secure session, a second administrative webpage for use by the test-taker and which enables the test-taker to access the secure session, and a virtual classroom graphical user interface (GUI) provided during the secure session, and which enables the test-taker to produce and export a completed assessment.

The export of the completed assessment may include at least one of emailing the completed assessment to the test-provider or uploading the completed assessment to a cloud folder accessible by the test-provider.

The portable case may include a cellular router providing wireless secure communications between the website and the USB drive.

The portable case may include a processor for configuring the USB drives.

The portable case may include at least one hub having an array of ports capable of accepting the USB drives.

Each USB drive may include a booting partition providing computer-readable instructions to start up a computer used by the test-taker during the secure session, and a main partition providing computer-readable instructions to run an operating system forming the secure session and enabling wireless transfer of the completed assessment from the USB drive to the website.

Each USB drive may include an additional partition for encrypted storage of the completed assessment.

The present disclosure provides an apparatus for use during secure administration of assessments, the apparatus comprising: a plurality of universal serial bus (USB) drives, at least one of the USB drives configurable by a test-provider via a website, the at least one USB drive enabling a secure session by the test-taker during an assessment; and a portable deployment case configured to provide secure communications between the website and the at least one USB drive, the portable deployment case including a cellular router, a processor, and a hub having an array of USB ports; wherein the cellular router is in wireless communication with the at least one USB drive and the website during the secure session.

The portable deployment case may include more than one hub.

The cellular router may be connected via Wi-Fi to each USB drive in use during the secure session and also connected via a cellular radio connection to the website during the secure session.

The at least one USB drive may include a booting partition to directly boot up a computer used by the test-taker during the secure session.

The at least one USB drive may include a main partition to operate the website on the computer used by the test-taker during the secure session.

The at least one USB drive may include an additional partition to encrypt and store therein the assessment upon completion by the test-taker during the secure session.

The processor may access and configure the plurality of USB drives.

### BRIEF DESCRIPTION OF THE DRAWINGS

Having thus generally described the nature of the invention, reference will now be made to the accompanying drawings, showing by way of illustration example embodiments thereof and in which:

FIG. 1 illustrates a typical configuration of a known assessment architecture.

FIG. 2 illustrates a configuration of assessment architecture in accordance with the present disclosure.

FIG. 3 illustrates a generalized diagram representing three primary components in accordance with the present disclosure.

FIG. 4 illustrates functional aspects of a USB device in accordance with the present disclosure.

FIG. 5 is a schematic including implementation details of the three primary components shown in FIG. 3.

FIG. 6A illustrates the functionalities of the web-facing component in accordance with the present disclosure.

FIG. 6B illustrates an architecture of the deployment component in accordance with the present disclosure.

FIG. 7 illustrates an architecture of the web-facing component in accordance with the present disclosure.

FIGS. 8 and 9 illustrate exemplary teacher administrative pages in accordance with the web-facing component of the present disclosure.

FIG. 10 illustrates an exemplary student administrative page architecture of the web-facing component in accordance with the present disclosure.

FIG. 11 illustrates a flow diagram showing teacher configuration of a new assessment in accordance with the present disclosure.

FIG. 12 illustrates a flow diagram showing student performance of an assessment in accordance with the present disclosure.

### DETAILED DESCRIPTION

In the following description of the embodiments, references to the accompanying figures are illustrations of one or more examples by which the invention may be practiced. It will be understood that other embodiments may be made without departing from the scope of the invention disclosed. Unless defined otherwise, all technical and scientific terms used herein have the same meaning as commonly understood by one of ordinary skill in the art to which the invention belongs.

The present disclosure provides a system and apparatus for secure testing in terms of providing an external device to run an operating system on a student-owned machine specifically to create a sealed environment (e.g., secure sandbox) for summative assessments (e.g., written tests). The system and apparatus advantageously precludes an individual (e.g., student) during the undertaking of a computerized testing session from using any software previously resident on their computer during the testing session. The system and apparatus further advantageously utilizes an operating system other than the operating system of the individual's computer. This is accomplished without any need for or use of any software previously resident on the individual's computer. In other words, the present system and apparatus establishes a testing session on the individual's computer that bypasses any software existing on the individual's computer including, but not limited to, the computer's existing operating system. This effectively provides a highly controlled environment (i.e., sealed environment, secure sandbox) during which the testing session may occur.

The present system and apparatus thus may utilize devices (e.g., laptop computer, tablet, desktop computer, or the like) owned by students while providing a testing session within the sealed environment. While the term “student” is discussed in the context of the present disclosure, it should be readily apparent that this term encompasses any individual engaged in testing or assessment. In accordance with the present disclosure, students are precluded from accessing certain hardware in their computers—such as their hard drive, USB drives, or DVDs—without permission. As well, students may also be restricted from transferring files into or out of the device without authorization and may have access only to a curated list of websites. It should be understood that such access to the curated list of websites occurs via a browser within the sealed environment rather than utilizing any browser that may be resident on the student's computer. Testing administrators (e.g., teacher, instructors, proctors, or the like) are thus ensured that any text or essay written on a student's computer during an assessment was not introduced from outside the given testing environment (e.g., classroom) nor may the student be able to remove materials from the testing session without permission.

As previously suggested above and for greater understanding of the present disclosure in the detailed description hereinbelow, it should be understood that the terms “teacher” and “student” will be used herein because one primary implementation of the invention as disclosed will be in a school context. However, it should be readily apparent that the invention as disclosed may be implemented in any context where its main users would not be specifically teachers and students. The term “teacher” should then be understood as any person who will use the system to manage and administer an assessment. The term “student” should be understood as any person who will be subjected to the assessment through the system.

The present system and apparatus overcome the disadvantages of the prior art in three primary ways including improvements in test-taker consent, overall security, and independence from the various operating systems pre-existing on the test-taker's computer (e.g., desktop/laptop workstation). In terms of consent for installation, it should be understood that student consent is easier to obtain as the student is assured that no applications, trackers, or files of any kind will be installed on their computer. The USB key method in accordance with the present disclosure leaves the student's computer exactly as it was before use. In terms of security, the USB key method in accordance with the present disclosure is highly secure as it provides its own operating system and may restrict functionalities at a granular level. In this manner, the test-taking user does not have access to their hard drive, cannot import files from external sources, and cannot export files from the key except through teacher-approved methods. In terms of operating system independence, the USB key method in accordance with the present disclosure uses a Linux environment, so it does not need to accommodate deeply integrated pre-existing software (e.g., office suites like those in Windows or macOS). Instead, the USB key method in accordance with the present disclosure provides access to open-source software that is self-contained and does not rely on cloud computing or online databases. This ensures a truly “sealed environment” for summative assessments.

In the context of the present specification, a “server” is a computer program that is running on appropriate hardware and is capable of receiving requests (e.g., from electronic devices) over a network (e.g., a communication network), and conducting those requests, or causing those requests to be conducted. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, conducting or causing to be conducted any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB (universal serial bus) keys, solid state-drives, tape drives, etc. A plurality of components may be combined to form the computer information storage media, including two or more media components of the same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the term “application” refers to a software present on an electronic device and provided with a user interface. The application may rely on a processor to process data and issue information. The application may also communicate over a communication network with a database.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of terms, for example “server” or “third server” are not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, the word “about” when used in relation to numerical designations or ranges means the exact numbers plus or minus experimental measurement errors and plus or minus 10 percent of the exact numbers.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams or illustrations represent conceptual views of the principles of the present technology. Similarly, it will be appreciated that any diagrams, flowcharts, and the like represent various processes which may be substantially represented in computer-readable media and so executed by a computer or processor, whether or not such computer or processor is explicitly shown.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

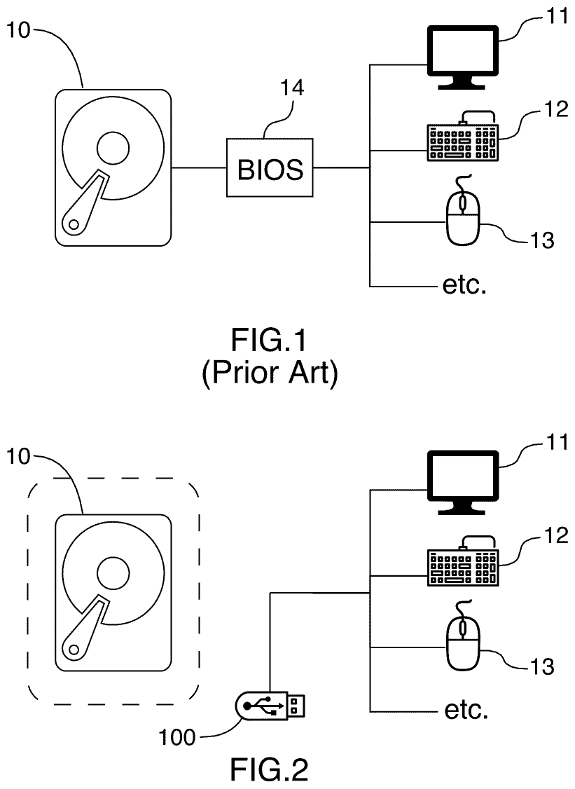

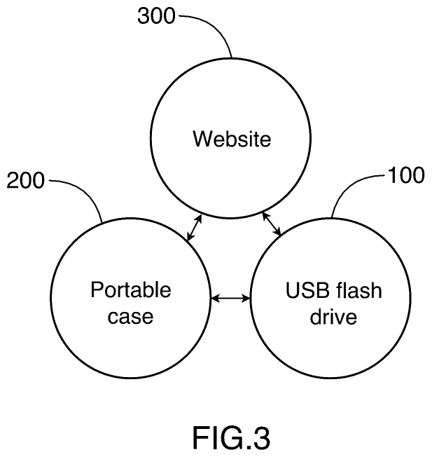

In contrast to the prior art configuration shown in FIG. 1 which impacts or otherwise engages with a given student's computer hard drive 10, the live session configuration of the present disclosure as shown in FIG. 2 does not require and therefore entirely bypass the given student's computer hard drive 10. As shown in FIG. 2, the hard drive 10 is therefore shown surrounded by a dotted line to indicate its isolation from the functional aspects of the present apparatus which include at least a monitor 11, a keyboard, 12, and a pointing device 13 (e.g., mouse). Here, a USB key 100 in accordance with the present disclosure is shown which effectively negates or otherwise substitutes for the function of the hard drive 10. FIG. 1 indicates that the operating system 14 (e.g., BIOS) is provided therein, while in FIG. 2 the operating system is included with the USB key 100 as further described hereinbelow.

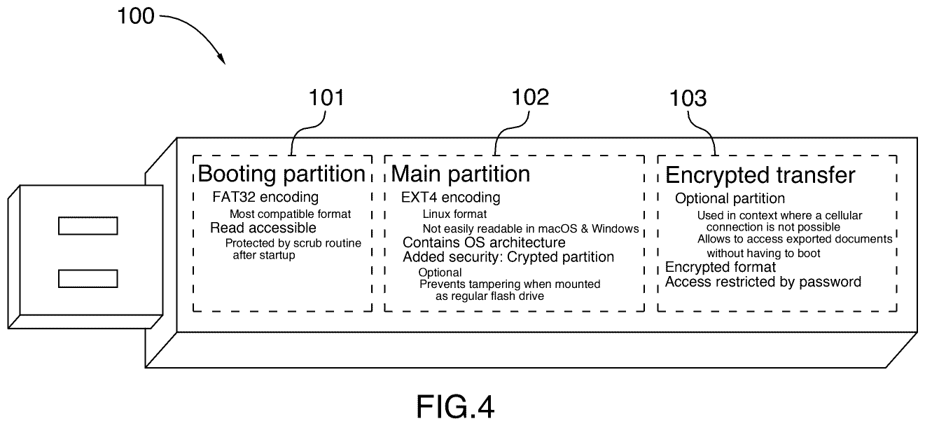

With reference to FIG. 3, the primary functional elements of an implementation of the present system and apparatus are illustrated in accordance with the present disclosure. It should therefore be understood that the present disclosure provides for a website 300 which may include graphical user interfaces for both the test administrator (e.g., teacher) and the test taker (e.g., student) embodied in a remote server, a USB key 100 in the form of a typical USB flash drive (i.e., thumb drive or the like) with software therein embodying the code underlying the present solution (e.g., testing software and operating system), and a portable case 200 which encompasses ports for at least an array of USB keys and a processing unit to interface with the USB keys and the remote server. This framework therefore represents the three primary functional elements of the inventive system and apparatus where the details of such functional elements are described further hereinbelow.

It should be understood that an advantageous aspect of the present disclosure is to use USB flash drives to boot a live session on student-owned computers in order to enforce a sealed environment where only authorized actions may be performed. In order to support the scaling up and deployment to an entire group of students (e.g., at a classroom-level population), an infrastructure that comprises the three primary functional elements of the inventive system and apparatus is created: a set of USB flash drives, a portable deployment case, and a web-based management platform. Together, these components provide a comprehensive approach to deploying, configuring, and managing secure computing environments in an educational setting. It is the combination of these components that provide unique and distinct advantages from any other existing alternative.

Each USB flash drive 100 is configured as a “live install” system using a Linux-based operating system provided on the USB drive itself. The configuration allows for persistent storage, enabling changes, and user-generated data to be retained across sessions. Every facet of the setup is geared towards creating a session where the student is precluded from importing by any means (e.g., USB drive, Bluetooth, internet, etc.) any document or file from outside the session. Any content created by the student to complete the assessment has to be created from inside the live session using the tools and documentation that the teacher has imported there beforehand. No content or file may be exported out of the session, except through a designated channel also configured by the teacher beforehand. Only whitelisted websites may be accessed by the student. By whitelisted, it should be understood that these are vetted websites which the student users are allowed to access during a testing session. The teachers are therefore assured that the assessment has been completed, as far as the computer on which it was performed is concerned, in a sealed environment where only the authorized tools and files are accessible to the student.

Each USB flash drive 100 may be stored and managed within the portable deployment case 200, which functions as a central hub for remote configuration and connectivity. The portable case 200 may contain multiple USB hubs, allowing for a plurality of USB flash drives to be housed and connected simultaneously. The USB hubs may interface with a compact computing device, such as a single-board computer, which may serve as the control unit (e.g., computer processor) for accessing and configuring the drives. Additionally, the deployment case may be equipped with a cellular router to provide an independent internet connection. This independent connection serves as a segregated network connection to ensure autonomy from public or institutional networks thereby allowing for secure remote management and granular control over the network connections created by the live installs.

The website 300 forms a web-based management platform that serves as the primary interface for file management and administrative tasks. This platform enables teachers to upload files to each USB flash drive 100, ensuring that file transfers occur within a sealed environment where access to local storage devices is restricted. This platform also links students to their designated USB drives via unique IDs. The drives may then be grouped into virtual classrooms corresponding to real-world class rosters thereby streamlining the management of files, permissions, and network settings. Such a “virtual classroom” is created for each portable case 200, where the student may find the authorized files and documentation during the assessment, and which offers the only channel through which the student may export a document out of the live session. This setup ensures that all data transfers are managed centrally through the website platform 300 thereby providing a safe and organized method for handling assessment content.

It should further be understood that the USB flash drives 100, portable case 200, and website 300 are provided, at every step of the process and in every material and digital aspect of the overall system and apparatus in accordance with the present disclosure, with physical locks, restricted access and encryption of sensitive files, logical partitions, databases and communications such that security and isolation are prioritized and enforced.

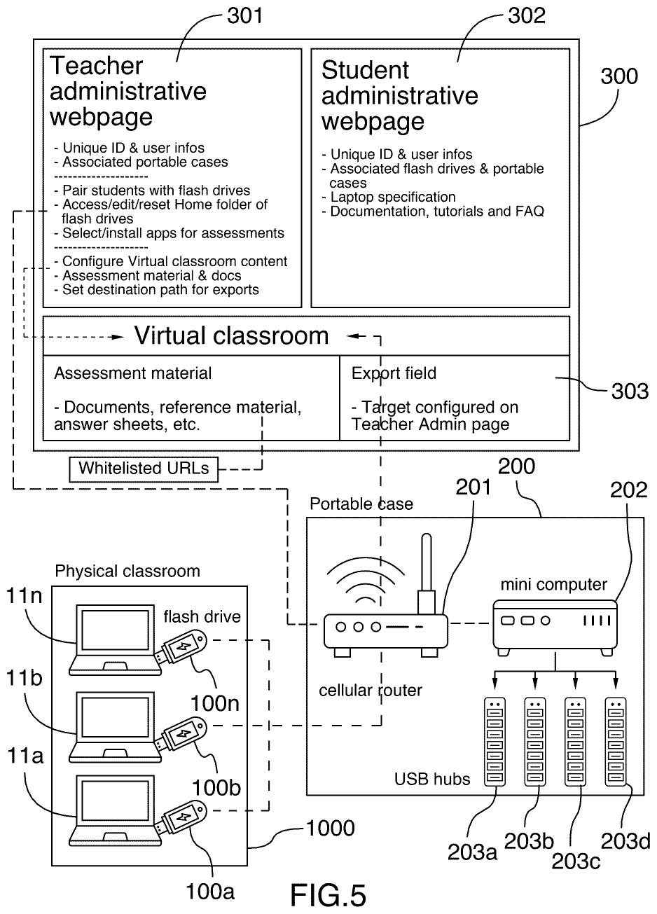

With reference to FIG. 4, the functional aspects of the USB key 100 in accordance with the present disclosure will now be discussed in greater detail. It should be noted that while a single USB key is shown and described, the plurality of USB keys (i.e., USB flash drives) are provided in any suitable number for any given implementation. For example, an assessment scenario may involve a classroom of fifty students with a corresponding number of USB keys required. Accordingly, the present system and apparatus are therefore scalable for any assessment scenario as will be evident by the further description hereinbelow. It should also be understood that any typical flash drive may be used as the USB keys in accordance with the present disclosure, though because the drive must hold a complete OS while still accommodating new files created by users, a minimum size of 8 GB is recommended. Each USB key is flashed with a distribution of Linux specifically tailored to run from USB flash drives. Instead of containing an ISO file that cannot be modified, these Linux distributions are fully deployed on the USB flash drive to record persistent changes to the system and write new files and documents that are preserved after reboot.

As seen from FIG. 4, the USB key 100 may include three partitions with a minimum of at least a booting partition 101 and a main partition 102. The booting partition 101 should contain all files necessary for the booting process of the student's computer. This may use the FAT32 file system which offers the advantage of being compatible with different systems and hardware. The size of the booting partition 101 generally does not need to exceed 1 GB, as the boot files require minimal space. The files on this partition are read-only thereby preventing tampering of their content. Special attention is needed for this partition, as it may be a potential vulnerability to the sealed environment. Moreover, because this partition is formatted in FAT32, it cannot be fully locked against writing without causing significant complications to the functioning of the overall system of the present disclosure. Accordingly, to mitigate any tampering on this partition and to prevent the introduction of a file into the sealed environment through this open door, a script is run during startup (after booting is completed).

The startup script is designed to ensure that no unauthorized modifications have been made to the boot partition. When the USB flash drive 100 is initialized, the script runs a checksum comparison on all critical files within the boot partition, comparing them to pre-computed values stored securely on the drive. If the checksum matches, the boot process proceeds as expected. If any discrepancies are detected, thereby indicating potential tampering, the script automatically resets the boot partition to its original state, thus erasing unauthorized files and restoring the validated configuration. This ensures that each assessment session starts with a clean, untampered environment. Optionally, the booting partition 101 may also contain branding elements, such as logos or messages, for personalization during the booting process.

The USB key 100 further includes a main partition 102 which include the Linux OS partition containing all files necessary for the Linux operating system (OS). The main partition 102 uses the EXT4 file system, which is native to Linux. It should be noted that the EXT4 file system is not easily accessible from Windows or macOS and which therefore helps restrict tampering. For additional security, the main partition 102 may be encrypted using an algorithm such as, but not limited to, LUKS (Linux Unified Key Setup). A key file is then added to the boot folder to facilitate decryption: a) when booting the live session, the key file decrypts the second partition without requiring a password; or b) when mounting the flash drive as a regular USB device on a session capable of reading EXT4, the user is prompted for a password to access the partition's content.

The OS architecture of the main partition 103 is preferably flexible and provides at least the following desired functionalities. In accordance with the present disclosure, the OS should be as minimal as possible to limit actions unrelated to the assessment. The OS should support adding and removing applications via modules (e.g., .xzm) and which allows teachers to select specific applications for different assessments. The OS should accommodate, through the administrative side of the teacher's webpage, the ability to block or allow peripherals on the student's computer. The desktop environment is streamlined and permits only the use of pre-installed applications, and the opening of files stored in the home folder. As previously suggested, the OS may enable the desktop environment to be personalized with branding elements such as logos or messages.

In terms of connectivity functionality, the OS will access the internet through a preconfigured Wi-Fi connection provided by a router in the portable case 200. This may include a firewall managed through a teacher administrative webpage of the website 300 that allows teachers to block all internet traffic except for a whitelist of approved websites. This internet connection also provides access to the virtual classroom, which is part of the website 300, serving as the primary manner for exporting documents from the sealed environment. It should further be noted that to enhance the security of the entire sealed environment, the OS may include a keylogger and comprehensive activity logging. This ensures that all actions performed by users during the assessment are recorded. Such keylogger may capture keystrokes to detect any attempts to circumvent restrictions or perform unauthorized actions during the session. Activity logs may track user actions, such as opening files, attempting to access blocked directories, and other relevant system interactions. These logs are securely stored on the USB drive thereby ensuring that any suspicious behavior may be reviewed by teachers or administrators. In terms of privacy considerations, the keyloggers and tracker log files may be stored in a secured folder in the OS architecture, and which are inaccessible to teachers or students. The logging functionality is intended solely for assessment security, and access to these logs is restricted to authorized personnel to maintain privacy. A request by the teacher to consult these logs should be filed through the administrative webpage and the student in question is to be notified. The logs are automatically erased after a sufficient period of time that may of course vary for any given implementation of the present invention as disclosed.

As mentioned, the USB key 100 may include at least a booting partition 101 and a main partition 102 as well as an optional third partition 103 in the form of an export partition. Optional partition 103 is intended for settings where a cellular connection is difficult or unavailable. Its purpose is to provide a manner of exporting files and documents from the live session when internet connectivity is not available through the router of the portable case. This third partition 103 may be encrypted using any suitable encryption software (e.g., VeraCrypt a free open source disk encryption software for Windows, Mac OSX and Linux provided by IDRIX SARL of Paris, France). By way of the encryption within the optional partition 103, when the student is ready to submit the assessment, the teacher unlocks the partition using a password. Later, when the teacher needs to access the assessment, the teacher mounts the USB key 100 in a hub slot and accesses the optional third partition 103 using the same encryption software, entering a corresponding password to thereby access the files. This optional method significantly speeds up the process of accessing completed assessments, as it avoids the need to boot each flash drive individually which may take several minutes per drive.

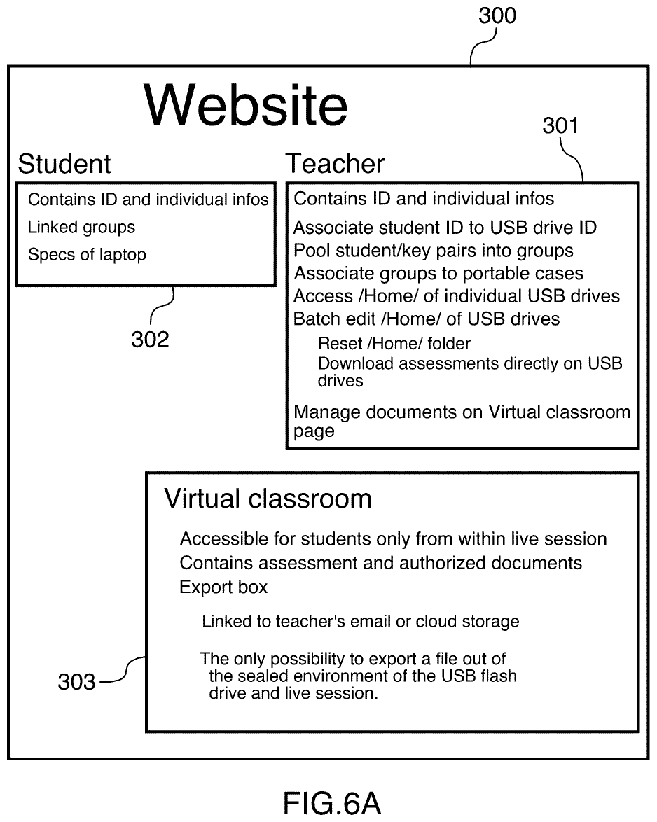

With reference to FIG. 5, there is shown a schematic including implementation details of the three primary components, namely USB key(s) 100, a portable case 200, and a website 300, shown in FIG. 3. As illustrated, n-number of USB keys 100a, 100b, . . . 100n may be provided which correspond with a physical classroom 1000 to corresponding number of student computers 11a, 11b, . . . 11n, where n is any integer greater than 1. Typically, any given classroom may include a wide-ranging number of students being assessed and the present disclosure may be advantageously scaled to any given student population. The implementation details as shown in FIG. 5 further illustrate a portable case 200 which may contain at least three main elements therein including: a cellular router 201, a processor 202 (e.g., microcomputer), and an array of USB hubs 203a to 203d. While four hubs are shown, it should be understood that any suitable array of any number of hubs may be provided without straying from the intended scope of the present disclosure.

The portable case 200 may further include any necessary accessory elements which may include, without limitation, power management, heat management, access ports, and the like, as may be well known in the electronics art and not further shown or described herein. The portable case 200 may therefore include all necessary devices to manage the distribution of power to every component. Likewise, the portable case 200 may include all necessary devices to manage the internal temperature. Further, portable case 200 may include all necessary physical ports to communicate with the router 201 or the processor 202. Still further, the portable case 200 may include a GPS tag in case of loss. Yet still further, the portable case 200 may include an optional backup battery pack to improve its versatility. Such an optional battery backup feature may of course increase the weight of the portable case 200 and may require additional manipulation by the teacher. It should of course be noted that the present system and apparatus as disclosed are preferably intended for use in a setting where multiple laptops are used by students thereby making access to AC power likely and relatedly reducing the optional need for battery back up.

As illustrated by dotted lines, the cellular router 201 is in wireless communication with the n-number of USB keys 100a, 100b, . . . 100n of the physical classroom 1000 and also in wireless communication with the website 300. It should be understood that the website 300 is embodied in a remote server which itself includes a processing unit as is well understood in the computer arts and not further shown or described herein. In this manner, the portable case 200 provides the gateway between the USB keys implemented in the physical classroom 1000 and the website 300 implemented remotely in a computing cloud environment.

It should be understood that the portable case 200 is designed to be easily carried by teachers while providing protection for the electronic components inside. The portable case 200 may be brought into the physical classroom during assessment periods. Materials for construction of the portable case 200 are selected for their shock-absorbing characteristics, as well as their lightness and resistance to repetitive and potentially rough handling. The portable case 200 may be closed by a physical lock (e.g., key or combination) to prevent tampering by unauthorized personnel. The portable case layout will take into account the mitigation of any interference between its electronics components. The portable case 200 may isolate its main components from direct contact by the teacher so as to prevent accidental damage and may of course be labeled as such—e.g., “no user serviceable parts”. Alternatively, the portable case 200 may form a protecting enclosure configured to be opened relatively easily to provided physical access to any individual component by a maintenance team.

The portable case 200 is intended to be powered by AC current, although an optional internal battery may be used without straying from the intended concept of the present disclosure. The teacher should have visual access to any LED lighting (i.e., operational indicators for monitoring apparatus functionality) from the electrical components of the portable case 200 so as to have visual feedback on the operations of the hardware. It should be noted that the teacher may physically access the hubs to insert and remove individual USB flash drives from the hubs, as the hubs are intended as the permanent housing space for the USB drives when not in use by the students during an assessment live session. The spacing of the USB hubs should be sufficient to allow labeling and identification of each individual space, with appropriate labeling material provided (e.g., stickers, rewritable tags, or the like). This allows the teacher to keep the USB hubs, ports, and keys organized. Such organization, for example, may involve color coding USB keys according to the given class (e.g., blue for Calculus I, orange for Calculus II, yellow for Advanced Geometry, . . . etc.). While such labeling, color coding, and the like are possible, it should be understood that the operation of the present apparatus and system may not require specific hub ports being assigned to specific USB keys in order to function. The overall portable case 200 is identified by a unique identifier. Providing such a unique identifier enables the portable case 200 to be “claimed” by a teacher through their teacher administrative webpage 301. A multi-factor authentication process is required to prevent unauthorized users from claiming the portable case 300.

With further reference to FIG. 5, aspects of the router 201 will now be discussed. As mentioned, the router 201 is a cellular-type router providing wireless communication among the primary elements of the present apparatus as disclosed. The router 201 therefore accommodates a SIM card that provides a proprietary connection to a cellular network in a manner well understood in the telecommunications art and not further shown or described herein. The router should be plug-and-play thereby minimizing any required interaction or intervention by the teacher. To further enable ease of operation by the teacher, powering up the portable case 200 correspondingly also powers on the router 201 automatically. It should be understood that having a segregated network (e.g., proprietary connection to a cellular network) provides independence from institutional networks (e.g., a school's Wi-Fi network, a commercial internet service provider, or the like), which avoids network security policies that may interfere with or restrict assessment functionality in accordance with the present disclosure. A proprietary connection to a cellular network also provides improved control over the configuration of the firewalls and other security aspects pertaining to the internet connection in place during operation of the present system and apparatus.

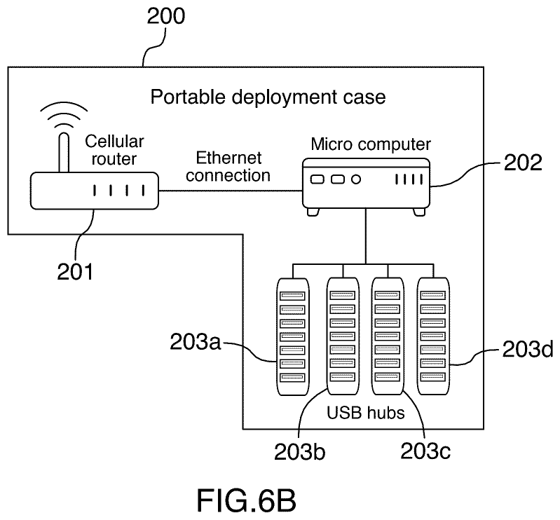

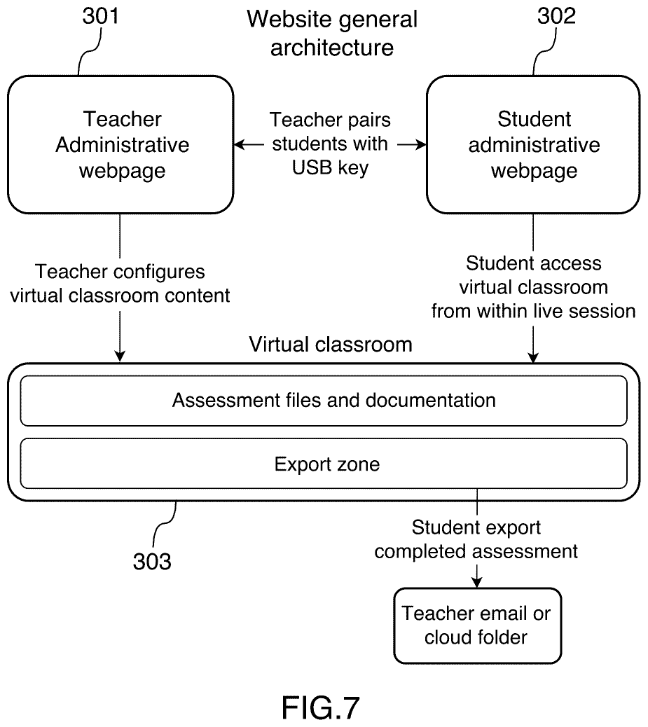

As the router 201 will include an antenna, the portable case 200 should be suitably dimensioned to provide adequate space for storing of the router's antenna(e). The router should be capable of managing a large number of device connections, which in turn determines the maximum number of USB flash drives the portable case 200 may support. The router 201 provides Wi-Fi connectivity for all USB flash drives 100a to 100n within the covered area (i.e., classroom setting) during live sessions. The Wi-Fi connection is preconfigured on all associated USB flash drives 100a to 100n, enabling automatic connection to the WLAN provided by the router 201 without input or any intervention from the student or teacher. It should be understood that all firewall settings for blocking or allowing internet traffic are managed through the teacher's administrative page 301 of the website 300 as described further hereinbelow. The internet connection is used for exporting completed assessments. However, if an internet connection is unavailable, the USB flash drives 100a to 100n may advantageously use the optional third partition 103 for file export. To further enhance security, the router 201 provides an ethernet connection to the processor 202 as shown in FIG. 6b for secure shell (SSH) tunneling.

With further reference to FIG. 5, the processor 202 will now be further described. In one implementation of the present disclosure, the processor may be a single-board computer such as, but not limited to, a Raspberry Pi 4. The processor 202 should preferably be plug-and-play, starting automatically when the portable case 200 is powered on to minimize teacher involvement. The processor 202 should preferably include a suitable number of ports to accommodate all connected USB hubs 203a to 203d. Likewise, it should be readily apparent that any number of hubs may be provided and need not be limited to the four as shown.

A function of the processor 202 is to facilitate communication between the teacher administrative page 301 and the associated USB flash drives 100a to 100n. The processor 202 also serves as the primary access point for IT administrators during system maintenance or troubleshooting. Moreover, it should be readily understood that the configuration of the processor 202 is restricted such that only the IT administrators have access—i.e., the configuration of the processor 202 is not accessible to teachers or students. The Linux OS operating on the processor 202 is selected and configured for its ability to facilitate SSH tunneling and to manage multiple connected USB hubs 203a to 203d.

With regard to the multiple connected USB hubs 203a to 203d, it is noted that the hubs should be powered by a dedicated power connector to prevent overburdening the processor 202. The hub slots serve as dedicated physical storage for the fleet of USB drives 100a to 100n. In other words, during times when assessment is not occurring and/or when the portable case 200 is in transport between live sessions, the USB drives 100a to 100n are housed safely and securely within corresponding hub slots among the given hubs 203a to 203d. Preferably, the hub slots may be spaced wide enough apart to allow adjacent labeling thereby making it easier for teachers to identify individual drives.

With continued reference to FIG. 5 and additional reference to FIGS. 6a and 7 through 10, further aspects of the website 300 will be described in greater detail. Generally speaking, the portable case 200 and its associated fleet of USB flash drives 100a to 100n (whether stored in their respective hubs or deployed to student computers during live sessions) are designed to integrate with the website 300 that serves three main purposes: recording necessary information about users (i.e., teachers and students); managing and configuring the content of the USB flash drives 100a to 100n; and providing a virtual classroom 303 where students may access relevant documentation, receive assessment instructions, and submit their completed assessments. It should be understood that recording user information along with managing and configuring content are functional aspects of the teacher administrative webpage 301 while provisions related to student-facing functional aspects are provided by the virtual classroom 303 of the website 300. It should be further understood that all transmissions (shown by dotted line) between the website 300 and the portable case 200 are protected via SSL encryption. As well, in terms of scalability, it should additionally be understood that multiple portable cases may be provided in wireless communication with a single website 300 without straying from the intended scope of the present disclosure.

In addition to the virtual classroom 303 itself which is a student-facing element of the website, there is also a student administrative page 302. In operation, the student administrative page 302 enables individual students to manage their own user information. Upon creating an account, the student must provide necessary individualized data including information such as, but not limited to, their name, name of their institution, specifications of the computer used for live sessions, and the like. Student accounts are password protected, and teachers have access to specific information only on a need-to-know basis. Additional student-centric directions such as, but not limited to, instructions for configuring the BIOS to boot from the USB are available at the student administrative page 302. Likewise, information such as, but not limited to, consent forms are also accessible for review by the student at the student administrative page 302. It should be noted that each student is assigned a unique identifier and via their student administrative page 302 students have access to the names of all portable cases with which they may be associated and therefore able to use for live sessions in accordance with the present disclosure. Accordingly, typical administrative tasks and functionalities available to students are limited to managing their personal information, though students also have access to a chat window for assistance with any aspect of the system. Such chat window assistance may be a live connection to the teacher administering the live assessment session and/or may be an artificial intelligence chatbot providing instantaneous answers to common questions that may be anticipated.

While the aforementioned student administrative page 302 is limited in scope to the context of student user, it should be understood that the teacher administrative page 301 provides substantially more capabilities. In terms of user information and similar to the student administrative page 302, the teacher must provide via their teacher administrative page 301 all required information which may include information such as, but not limited to, their name, name of their institution, and the like. Upon creating their account, each teacher is issued a unique ID number. Once registering or otherwise initiating their account, the teacher is then able to engage in a wide array of administrative tasks.

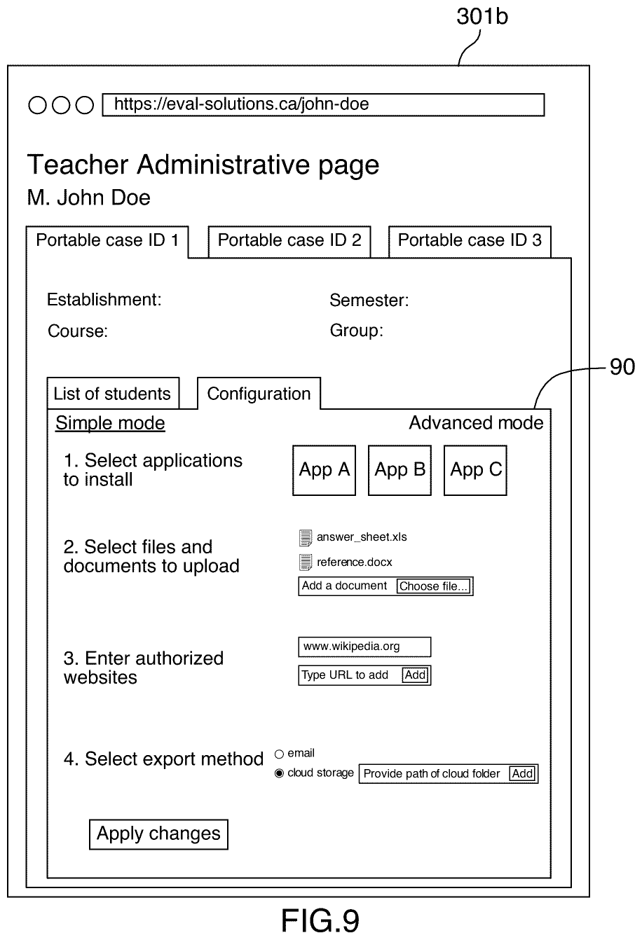

Teacher administrative tasks may include managing USB drives, portable cases, and student rosters. For example, a teacher may have several portable cases at any given time, each corresponding to a group of students, a class, or a part of a class. In such situations, the teacher associates all portable case unique identifiers to their account. Once a portable case has been claimed by a teacher, they may associate each USB flash drive correspondingly with a specific student by matching a student's unique ID with the given USB flash drive's unique ID. As should be readily apparent, teachers have access to certain student information solely for this purpose. The security of this matchmaking process is reinforced with multifactor authentication, ensuring that only vetted (i.e., confirmed and authorized) students may be linked to USB drives. Teachers may access their list of associated portable cases via their given teacher administrative page, each containing the list of paired students 80 and USB drives such as shown by way of the menu-driven graphical user interface 301a in FIG. 8.

Teacher administrative tasks may also include managing boot procedures for specific student builds—i.e., each student's given computer environment may vary. This may involve compatibility adjustments whereby different computer brands may require distinct boot configurations, necessitating changes to files on the boot partition. Via their given teacher administrative page, there is enabled teacher customization whereby teachers may select a specific brand for an individual student, and the website 300 will automatically push the appropriate configuration to the boot partition 101 of the student's associated USB drive 100.

It should be noted that the teacher's administrative tasks in conjunction with the present disclosed system and apparatus provides freedom to the teacher in designing secure assessments for any coursework or subject matter. Thus, the system and apparatus provide testing and assessment that is fully customizable by the teacher while simultaneously being substantially closed, limited, and securely isolated from the vantage of the student being assessed.

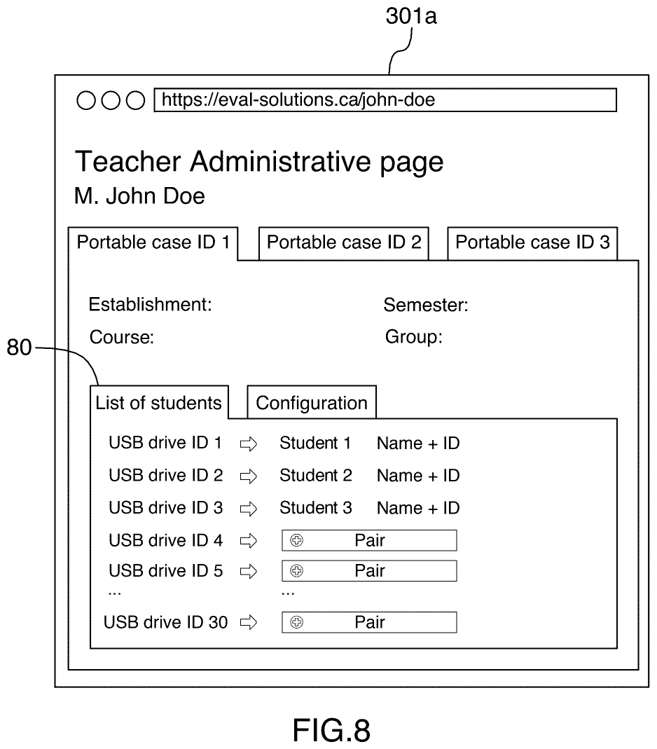

With reference to FIG. 7, there is shown an architecture of the web-facing component in accordance with the present disclosure. The teacher administrative webpage 301 and the student administrative webpage 302 are in communication for at least the purpose of pairing students with a corresponding USB key. Both the teacher administrative webpage 301 and the student administrative webpage 302 may access the virtual classroom which includes the assessment files and documentation configured by the teacher and the export zone which allows the student to export their completed assessment file to teacher email or a cloud folder.

Still further, teacher administrative tasks may include managing the content of the USB flash drives. This is accomplished whereby teachers select the applications needed for a particular assessment task by choosing from a menu-driven graphical user interface having list of available applications such as shown in by way of the interface 301b in FIG. 9. Once the teacher applies the changes, the website sends the command to uninstall extraneous software and add only the necessary applications in the form of modules (e.g., .xzm format). By default, the firewalls on each USB flash drive 100 blocks all internet traffic except for the URL of the virtual classroom 303 of the website 300 that is associated with or otherwise assigned to each portable case 200.

Teachers may configure a whitelist of domain names which may additionally be permitted during the assessment. Such whitelisted websites may be set as homepages in the browser on the USB drives to automatically open upon browser launch to further guide students in an efficient manner and help maintain the secure sandbox during the live session. Similarly, teachers may upload any approved documentation they wish to make available to students through the virtual classroom page such as, but not limited to, reference materials, assessment instructions, answer sheets, or the like. FIG. 5 shows whitelisted URLs 304 by dotted line connection to the assessment material of the virtual classroom 303 thereby illustrating that the whitelisted sites are accessible by, though not integral to, the virtual classroom.

Teachers may configure a predetermined manner of receiving completed assessments either by providing an email address or by providing a URL linked to a cloud storage folder. This is established in an export box of the virtual classroom. The overall graphical user interface of the webpage is arranged and presented to simplify the process of configuring the USB drives as much as possible. An advanced mode, in contrast to simple mode, in the configuration tab 90 as shown in FIG. 9 may be provided to enable the teacher to customize configurations on an individual basis, enabling them to select specific USB drives to include different application modules, different documentation, . . . etc.

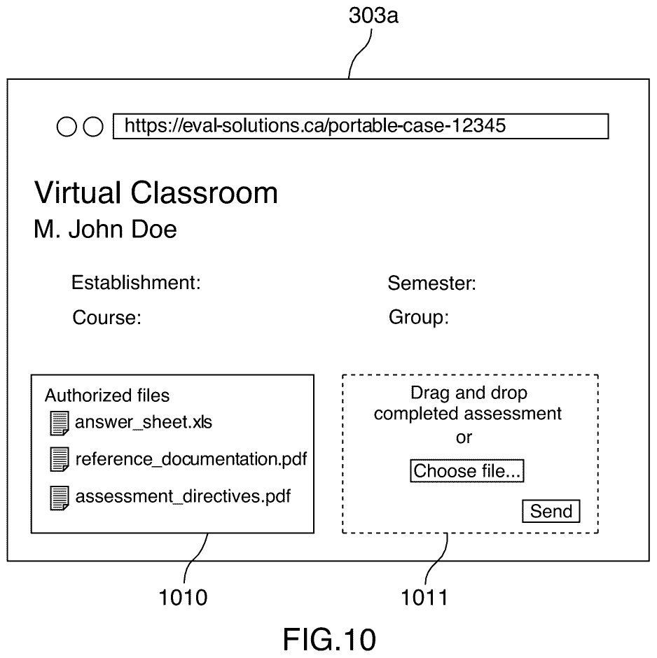

With reference to FIG. 10, there is illustrated an exemplary student administrative page where it may be noted access to USB flash drive content is provided by a repository of authorized files 1010. While the virtual classroom 303a provides an official export box 1011, teachers may also have remote access to students' home folders including the repository of authorized files 1010 whereby either party (student and teacher) may read and download any files stored there. In practice, teachers may reset the home folders on USB flash drives to prepare each USB flash drives for the next term.

It should be further understood that communication with technical support may occur within the webpage as previously suggested such as via a chat window available in the teacher administrative webpage for teachers to reach technical support for assistance with any aspect of the system embodying the system and apparatus of the present disclosure. Any requests to consult activity logs or keylogger files must be submitted through technical support and will be communicated to the student to further enhance user trust and transparency.

With continued reference to FIG. 10 with regard to the virtual classroom, it should be understood that each portable case includes a dedicated virtual classroom assigned thereto. For example, the URL indicated in FIG. 10 denotes, for example, http://eval-solutions.ca/portable-case-12345 which is a unique URL corresponding to a virtual classroom assigned to portable case number 12345. To ensure security in accessing any such given unique URL, the virtual classroom is a webpage that is only accessible through a live session using token identification. It should be readily apparent that token identification is a well understood manner of ensuring secure internet connections and will not be discussed in full. However, token identification in the context of the present system and apparatus as disclosed occurs when students log into the live session on their associated USB flash drive and launch the browser, which prompts a token verification request from the virtual classroom. Students trying to access the virtual classroom URL from any device other than the valid USB flash drive associated with the portable case will be denied access thus assuring the integrity of the secure sandbox in which the live session exists. Likewise, it should be noted that the content of the virtual classroom may only be configured through the teacher administrative page associated with the corresponding portable case further ensuring security.

As previously suggested, the layout (i.e., GUI) is designed for ease of use which includes the interface of the virtual classroom having large icons for files and straightforward navigation to provide clear instruction to students and minimize distractions during assessments. The virtual classroom webpage 303a includes a portion for documents shown as authorized files 1010 and a portion for completed work shown as drag and drop 1011. The documentation portion may be structured as a grid containing all the documents uploaded by the teacher for the given assessment. Here, students may open any file provided to review its content or to edit it (e.g., official answer forms). Whereas the portion for completed work is effectively a drop box section configured for submitting (i.e., exporting) finished assessments as the end product (i.e., output) of the live session. The GUI may therefore include a file selection field and a drag-and-drop zone for uploading. A submit button (i.e., send) transmits the file to the target specified by the teacher on their administrative page. For enhanced data integrity, metadata-like timestamps and user IDs may be added to the file and/or the email body to facilitate tracking submissions and providing a validity component to all completed assessments. Confirmation feedback may be provided to the student for failed or successful file transfers of the completed assessments, though the student does not have access to the path of the target repository for the completed assessments thereby assuring no ability for the student to tamper with their completed assessment.

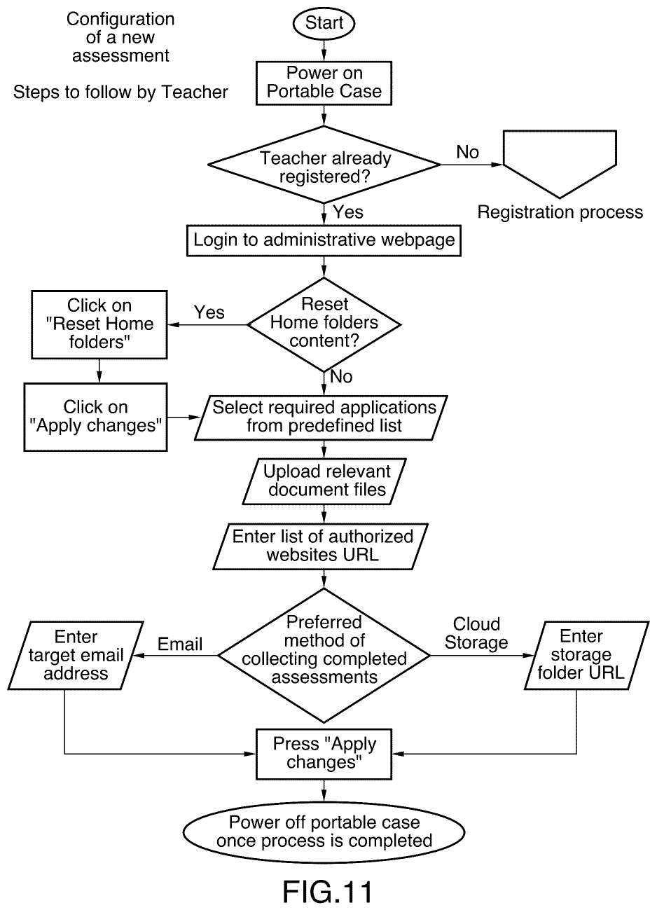

With reference to FIG. 11, there is illustrated a flow diagram showing teacher configuration of a new assessment during operation of the present system and apparatus in accordance with the present disclosure. The configuration method begins with the teacher powering on the portable case before a determination is made whether the teacher is already registered with the given case. If not, teacher registration will occur. Once registered, the teacher will log into the teacher administrative webpage. Next, a determination will be made to reset the home folders. It should be noted that this reset of the home folders would occur in situations such as when a new assessment should come into being. However, if the assessment is established, there would of course be no need to reset the home folders. Regardless, the teacher will then select any required applications from a predefined list, upload any requisite document files, and enter the URLs for any whitelisted websites that will be accessible by the student in the virtual classroom. The teacher will then select the preferred method for collecting the student's completed assessments (e.g., via email or cloud storage), then will enter either the email address or cloud storage URL before applying these changes and subsequently powering off the portable case to complete the configuration process.

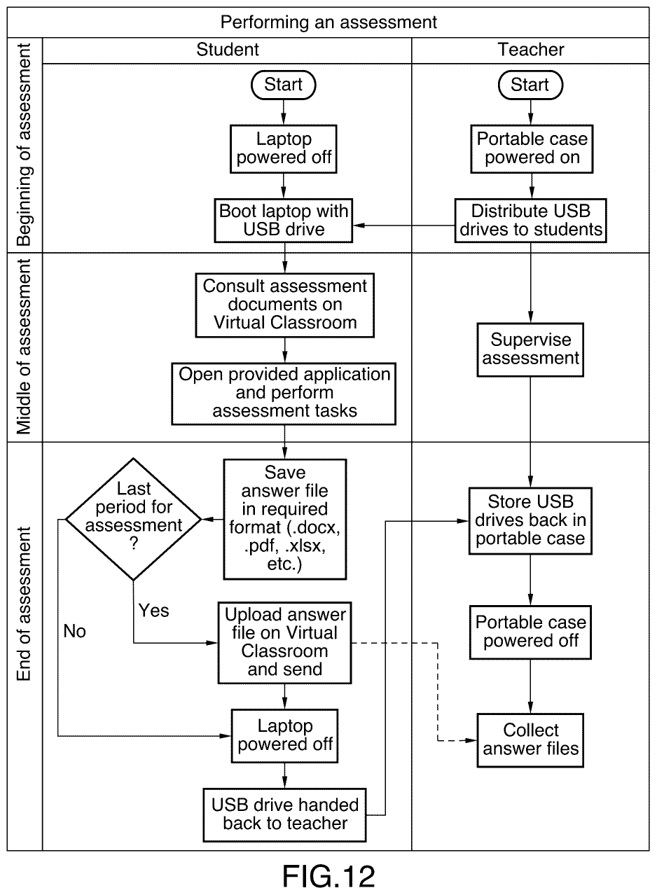

FIG. 12 illustrates a flow diagram showing student performance of an assessment during operation of the present system and apparatus in accordance with the present disclosure. Student performance of an assessment begins with the student powering up their computer (e.g., laptop) booted with their respective USB drive distributed to them by the teacher. The teacher, in their part, ensures that the portable case is powered on. As previously described hereinabove, the portable case via its cellular router provides secure connectivity between each USB drive and the webpage that includes the virtual classroom. Once the student's computer booted with the USB drive is active, the student will consult the assessment documents residing within the virtual classroom, open the application previously configured by the teacher, and thus perform the given assessment while the teacher supervises. Once the student has completed the assessment, the student uploads their completed assessment to the virtual classroom, powers off their computer, and returns their USB drive to the teacher who then stores each drive in the appropriate hub port of the portable case, powers off the portable case, and collects the completed assessments through the teacher administration webpage.

The embodiments described above are intended to be exemplary only. The scope of the invention is therefore intended to be limited solely by the claims appended hereto. Those skilled in the art will recognize, or be able to ascertain, using no more than routine experimentation, numerous equivalents to the specific procedures, embodiments, claims, and examples described herein. Such equivalents are considered to be within the scope of this invention and covered by the claims appended hereto.

1) A system for securely administering assessments, the system comprising:
an external device providing an operating system on a student-owned machine to create a sealed environment for summative assessments;
one or more websites enabled by the operating system to be accessible by the student-owned machine; and
a management component for enabling administration of the external device and the one or more websites.

2) The system as claimed in claim 1, wherein during an assessment session, the student-owned machine is precluded from using any preexisting software resident therein.

3) The system as claimed in claim 2, wherein the management component includes a web-based management platform.

4) The system as claimed in claim 3, wherein the external device includes a plurality of universal serial bus (USB) flash drives.

5) The system as claimed in claim 4, wherein the management component further includes a portable deployment case in communication with the web-based management platform, the portable deployment case for containment of the plurality of USB flash drives.

6) A system for securely administering assessments, the system comprising:
a website accessible by at least two individuals including a test-taker and a test-provider;
a plurality of universal serial bus (USB) drives, at least one of the USB drives configurable by the test-provider via the website, the USB drive enabling a secure session by the test-taker during an assessment; and
a portable case configured to provide secure communication between the website and the USB drive.

7) The system as claimed in claim 6, wherein the website includes
a first administrative webpage for use by the test-provider and which enables the test-provider to configure the secure session,
a second administrative webpage for use by the test-taker and which enables the test-taker to access the secure session, and
a virtual classroom graphical user interface (GUI) provided during the secure session, which enables the test-taker to produce and export a completed assessment.

8) The system as claimed in claim 7, wherein the export of the completed assessment includes at least one of emailing the completed assessment to the test-provider or uploading the completed assessment to a cloud folder accessible by the test-provider.

9) The system as claimed in claim 8, wherein the portable case includes a cellular router providing wireless secure communications between the website and the USB drive.

10. The system as claimed in claim 9, wherein the portable case includes a processor for configuring the USB drives.

11. The system as claimed in claim 10, wherein the portable case includes at least one hub having an array of ports capable of accepting the USB drives.

12. The system as claimed in claim 11, wherein each USB drive includes
a booting partition providing computer-readable instructions to start up a computer used by the test-taker during the secure session, and
a main partition providing computer-readable instructions to run an operating system forming the secure session and enabling wireless transfer of the completed assessment from the USB drive to the website.

13. The system as claimed in claim 12, wherein each USB drive includes an additional partition for encrypted storage of the completed assessment.

14. An apparatus for use during secure administration of assessments, the apparatus comprising:
a plurality of universal serial bus (USB) drives, at least one of the USB drives configurable by a test-provider via a website, the at least one USB drive enabling a secure session by the test-taker during an assessment; and
a portable deployment case configured to provide secure communication between the website and the at least one USB drive, the portable deployment case including a cellular router, a processor, and a hub having an array of USB ports;
wherein the cellular router is in wireless communication with the at least one USB drive and the website during the secure session.

15. The apparatus as claimed in claim 14, wherein the portable deployment case includes more than one hub.

16. The apparatus as claimed in claim 15, wherein the cellular router is connected via Wi-Fi to each USB drive in use during the secure session and also connected via a cellular radio connection to the website during the secure session.

17. The apparatus as claimed in claim 14, wherein the at least one USB drive includes a booting partition to directly boot up a computer used by the test-taker during the secure session.

18. The apparatus as claimed in claim 17, wherein the at least one USB drive includes a main partition to operate the website on the computer used by the test-taker during the secure session.

19. The apparatus as claimed in claim 18, wherein the at least one USB drive includes an additional partition to encrypt and store therein the assessment upon completion by the test-taker during the secure session.

20. The apparatus as claimed in claim 14, wherein the processor accesses and configures the plurality of USB drives.
